(19) United States
(12) Patent Application Publication
(10) Pub. No.: US 2008/0096596 A1
(43) Pub. Date: Apr. 24, 2008

(54) Apparatus And Method For Optimising A Spread Spectrum Cellular Communication System

(75) Inventor: Chris Murphy, Bath (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/908,509

(22) PCT Filed: Feb. 27, 2006
(86) PCT No.: PCT/US06/06819

§ 371 Date: Sep. 13, 2007

(30) Foreign Application Priority Data
Mar. 22, 2005 (GB) 0505832.6

(51) Int. Cl. H04B 1/707; H04Q 7/00

(52) U.S. Cl. 455/500; 375/141

(57) ABSTRACT

An optimisation apparatus (100) for optimising a spread spectrum cellular communication system comprises a measurement report processor (101) which collects measurement reports from remote units of the spread spectrum cellular communication system. The measurement report processor (101) is connected to a path loss processor (103) which determines relative path loss data for the remote units. The relative path loss data may comprise path loss data relative to a constant which is common for a plurality of neighbour cells of a remote unit. The path loss processor (103) is coupled to a model processor (105) which establishes a model of the cellular communication system in response to the relative path loss data. The model processor (105) is coupled to a performance data processor (109) which generates estimated performance data for the cellular communication system from the model. Estimated performance data may be generated for different parameter values and the optimum parameter value may be selected and applied to the cellular communication system.

### FIELD OF THE INVENTION

The invention relates to a method and apparatus for optimising a spread spectrum cellular communication system and in particular to generation of estimated performance data for optimisation of a cellular communication system.

### BACKGROUND OF THE INVENTION

Cellular communication systems have become ubiquitous over the last decade and the wireless cellular communications have become increasingly popular. In order to efficiently use the available resources in a cellular communication system, it is desirable that the cellular communication system operates as close to optimal as possible.

Accordingly, substantial amounts of resources are spent on designing and optimising cellular communication systems to fully utilise that available resources.

In particular, a live cellular communication systems comprise many parameters that must be suitably selected and adjusted to efficiently use the available air interface resource and to provide a high quality of service to the subscribers.

Furthermore, the parameters are interrelated and affect performance in complex and sometimes unexpected ways. In particular, base stations and mobile stations create interference for other base stations and mobile stations and improving conditions for one unit (e.g. by increasing transmit power) may reduce conditions for another (by increasing the interference).

In a spread spectrum communication system, the transmit signals occupy the same frequency channel(s) and are separated by spreading codes. For example, 3^{rd} generation cellular communication systems utilise spread spectrum techniques. The most widely adopted 3^{rd} generation communication systems are based on Code Division Multiple Access (CDMA) wherein user separation is obtained by allocating different spreading and scrambling codes to different users on the same carrier frequency. The transmissions are spread by multiplication with the allocated codes thereby causing the signal to be spread over a wide bandwidth. At the receiver, the codes are used to de-spread the received signal thereby regenerating the original signal. Each base station has a code dedicated for a pilot and broadcast signal, and this is used for measurements of multiple cells in order to determine a serving cell and possible handover candidates. An example of a communication system using this principle is the Universal Mobile Telecommunication System (UMTS).

In order to optimise the performance of, for example, a 3^{rd} generation CDMA system, it is necessary to consider many different factors including the propagation conditions, location distribution of mobile stations, traffic distributions of mobile stations, location of base stations, transmit and receive parameters of base stations and mobile stations etc.

In order to determine suitable parameters of a cellular communication system, various design tools are frequently used. In particular, simulation systems are frequently used to simulate the performance of the cellular communication system thereby providing performance data for the parameters of the underlying simulation model. By varying the parameters and evaluating the results, improved parameter settings may be determined.

The simulation model is typically developed by determining a geographical model wherein the location of base stations is known. A propagation model is then included based on e.g. measured or calculated propagation data. This allows the signal levels from different base stations at a given location to be determined. A distribution of mobile stations are then randomly located in the geographical model (known as a “drop”) and the performance (e.g. the signal to noise ratio) for the mobile stations are determined. The drop of the mobile stations may be affected by a probability indication of where mobile stations are likely to be in the real system. Also, a range of different services may be assumed for the distribution of mobile stations. In order to get statistically accurate results a large number of drops are typically generated (each drop corresponds to a snapshot of a possible situation in the cellular communication system).

Although such simulators may provide information which is useful for optimising cellular communication systems, they tend to have a number of associated disadvantages.

Firstly, the accuracy of the simulations is typically less than desirable. In particular, the simulations are typically based on a number of assumptions, such as assumed or estimated traffic distributions, propagation conditions, mobile station locations etc, which only approximately reflect actual conditions. Accordingly, the performance estimates typically do not accurately reflect the real conditions.

Furthermore, in order to generate useful data, accurate parameters must be used for the model thereby requiring that accurate information of the real cellular communication system must be obtained. In addition to the system parameters and topology of the cellular communication system, the propagation characteristics, use characteristics and traffic characteristics must be known accurately. However, such information is very difficult and cumbersome to obtain.

For example, data regarding the actual propagation loss between all base stations and arbitrary locations in the network can be measured using the dedicated efforts of drive test teams. However, this will only provide data for routes covered by the drive test and is very time and resource intensive. Furthermore, comprehensive values for in-building propagation losses are almost impossible to determine.

Also, generating traffic characteristic information to a resolution finer than the cell level is difficult and requires assumptions about correlations between mobile station usage and the locations of roads, offices, homes, commercial centers etc.

Determining required mobile station parameters, such as target signal to noise ratios and voice activities, to a sufficient accuracy and for a sufficient number of mobile stations is also difficult and resource demanding.

Also, the simulations require a substantial number of drops to achieve statistically reliable results. This results in a high computational requirement and a slow optimization process.

Hence, an improved system for optimising a spread spectrum cellular communication system would be advantageous and in particular a system allowing increased flexibility, improved accuracy, reduced computational resource demand, a faster optimisation process, facilitated operation, reduced information requirements, facilitated information gathering and/or improved performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an apparatus for optimising a spread spectrum cellular communication system, the apparatus comprising: means for collecting measurement reports from remote units of the spread spectrum cellular communication system; means for determining relative path loss data for the remote units; means for establishing a model of the cellular communication system in response to the relative path loss data; means for generating estimated performance data for the cellular communication system from the model.

A characteristic of the cellular communication system may be modified in response to the estimated performance data.

The invention may allow improved and/or facilitated optimisation of a spread spectrum cellular communication system. Measurement reports from remote units may be used to determine relative path loss data thereby allowing an accurate model to be established. Increased accuracy may be achieved resulting in improved optimisation of the cellular communication system thereby improving the performance of a cellular communication system as a whole.

The requirement for manual collection of data may be eliminated or reduced by the invention. The use of measurement rates may automatically generate data reflecting the geographical distribution and/or traffic distribution of the cellular communication system.

Optimisation based on a model using relative path loss data is particularly applicable to and advantageous for a spread spectrum cellular communication system where the remote units share a frequency channel.

The invention allows for a simplified model and/or facilitated determination of performance data. In particular, statistically reliable estimated performance data may be achieved without requiring repeated evaluations of the model (i.e. without necessitating repeated drops).

Optimisation of a cellular communication system comprises the process of seeking to improve performance in a cellular communication system rather than necessarily modifying the system to achieve a theoretical or absolute optimum performance.

The measurement reports may be received from all or only some remote units of a cell, a group of cells or the whole communication system. The optimisation of the communication system may relate to an optimisation of the system as a whole or to only a subset of the communication system, such as a specific geographical area or a group of cells.

The relative path loss data may specifically reflect the relative path loss between a plurality of base stations and the same remote unit. The relative path loss may specifically comprise path loss data for a remote unit relative to a constant which is common for a plurality of neighbour cells of the remote unit. The common constant may for example be an interference contribution for interference sources for which individual measurement values are not included.

The model may typically be established by determining suitable parameter values for a predetermined mathematical model having a number of adjustable parameters. In particular, a predetermined model comprising a number of base stations and cells in a known relationship may be modified to reflect the relative path loss between different cells.

The remote units may for example be a communication unit, a wireless user equipment, a 3^{rd} generation UE, a subscriber unit, a mobile station, a communication terminal, a personal digital assistant, a laptop computer, an embedded communication processor or any communication functionality communicating with a base station over the air interface.

According to an optional feature of the invention, the model comprises a number of variable parameters and the means for generating the estimated performance data comprises means for altering a parameter value and generating estimated performance data for the altered parameter value. This may improve performance and allow a practical implementation.

According to an optional feature of the invention, the measurement reports comprise signal level indications for a plurality of cells from at least a first of the remote units.

This may improve performance and allow a practical implementation. The signal level indications may be indicative of measurements of signals from a plurality of base stations within a given time interval.

According to an optional feature of the invention, the signal level indications are signal to interference measurements. The signal to interference measurements may for example be signal to interference values determined from received signal power measurements. The signal to interference measurements may for example be pilot channel Ec/Io values determined for individual remote units.

According to an optional feature of the invention, the plurality of cells for the first remote unit comprises cells of an active set of the first remote unit. The active set may specifically comprise cells supporting a soft handover for the first remote unit. This may allow accurate performance data estimation and a practical implementation. In particular, it may provide high compatibility and suitability for existing communication systems such as UMTS.

According to an optional feature of the invention, the plurality of cells for the first remote unit comprises cells of a candidate set of the first remote unit. The candidate set may specifically comprise cells of candidates for a soft or hard handover for the first remote unit. The candidate set may comprise cells indicated in a neighbour list transmitted to the first remote unit. This may allow accurate performance data estimation and a practical implementation. In particular, it may provide high compatibility and suitability for existing communication systems such as UMTS.

In some embodiments, the plurality of cells for the first remote unit may comprise cells of a detected set of the first remote unit. The detected set may specifically comprise cells neither in the active set nor in the candidate set for the first remote unit. The detected set may comprise cells that the first remote unit has measured without external guidance from the network. This may allow accurate performance data estimation and a practical implementation. In particular, it may provide high compatibility and suitability for existing communication systems such as UMTS.

According to an optional feature of the invention, the relative path loss data for a second remote unit comprises a relative path loss estimate for a plurality of cells and the model comprises means for determining a signal to interference estimate for the second remote unit in response to the relative path loss estimates.

This may allow accurate estimated performance data and thus an improved optimisation. The feature may be particularly suited for spread spectrum systems wherein signals from different base stations share a frequency interval.

According to an optional feature of the invention, at least one of the plurality of cells is a serving cell of the second remote unit and at least one of the plurality of cells is a non-serving cell.

This may allow accurate estimated performance data and thus an improved optimisation. The feature may be particularly suited for spread spectrum systems wherein signals from different base stations share a frequency interval. In particular, accurate signal to interference estimates may be determined from relative path loss values from a serving cell and close interfering cells.

According to an optional feature of the invention, the apparatus further comprises means for estimating a location of at least some of the remote units and the means for establishing the model is arranged to establish the model in response to the estimated locations.

This may further improve the estimated performance data and provide an improved optimisation.

According to an optional feature of the invention, the means for determining relative path loss data is arranged to compensate the relative path loss data for at least one remote unit in response to an interference level of interference sources not included in measurement reports for the third remote unit. This may further improve the estimated performance data and provide an improved optimisation.

According to an optional feature of the invention, the apparatus further comprises calibration means for calibrating the model in response to an operational characteristic of the cellular communication system.

This may improve the accuracy of the estimated performance data and thus may improve the optimisation. Alternatively or additionally, it may facilitate implementation.

The operational characteristic may be a characteristic determined from an operational system which is being optimised. Thus, the model may be calibrated in response to actual measurements of an operational system. The calibration may comprise modifying at least one estimated parameter, such as an unknown parameter value of the model.

According to an optional feature of the invention, the calibration means comprises: means for determining a first set of parameter values for the model; comparing a first characteristic of the estimated performance data to the operational characteristic; and means for modifying at least one parameter of the first set of parameters in response to the comparison.

The first set of parameters may for example comprise initial estimates for unknown parameters which may subsequently be modified by comparing the estimated performance data resulting from these parameter values to actual measured values. This may provide a highly effective, accurate and/or practical way of improving estimates for unknown parameters. This may improve the accuracy of the estimated performance data and thus may improve the optimisation. Alternatively or additionally, it may facilitate implementation.

According to an optional feature of the invention, the means for determining the first set of parameters is arranged to determine the first set of parameters in response to the measurement reports. This may result in a practical implementation and/or improved performance.

According to an optional feature of the invention, the calibration means comprises means for modifying the first set of parameter values in response to the at least one parameter and for iterating the calibration of the model.

This may provide a particularly low complexity and accurate way of determining appropriate parameter values.

According to an optional feature of the invention, the apparatus further comprises means for determining an antenna direction in response to the estimated performance data.

The invention may be particularly suitable for the determination of an antenna direction such as the downtilt or azimuth of one or more base station antennas of one or more cells.

According to an optional feature of the invention, the apparatus further comprises means for determining a pilot signal transmit power level in response to the estimated performance data. The invention may be particularly suitable for the determination of a pilot signal transmit power level of one or more cells.

According to an optional feature of the invention, the cellular communication system is a Universal Mobile Telecommunication System, UMTS, communication system. The invention may provide particularly advantageous optimisation of a UMTS spread spectrum cellular communication system.

According to a second aspect of the invention, there is provided a method of optimising a spread spectrum cellular communication system, the method comprising: collecting measurement reports from remote units of the spread spectrum cellular communication system; determining relative path loss data for the remote units; establishing a model of the cellular communication system in response to the relative path loss data; generating estimated performance data for the cellular communication system from the model.

A characteristic of the cellular communication system may be modified in response to the estimated performance data.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an optimisation apparatus for optimisation of a spread spectrum cellular communication system in accordance with some embodiments of the invention; and

FIG. 2 illustrates an example of a method of optimising a spread spectrum cellular communication system in accordance with some embodiments of the invention.

### DETAILED DESCRIPTION OF EMBODIMENTS OF THE INVENTION

The following description focuses on an embodiment of the invention applicable to optimisation of a UMTS cellular communication system. However, it will be appreciated that the invention is not limited to this application but may be applied to many other applications and communication systems.

Optimisation of cellular communication system by modification of various parameters for the cellular communication system is of the utmost importance in order to efficiently utilise the available resource. However, as many interrelated parameters can be adjusted and the performance impact is highly complex, interrelated and difficult to estimate, tools for predicting the performance implications of varying parameters of the system are essential.

For example, in UMTS cellular communication system a large number of base stations and remote units operate in the same frequency interval i.e. the signals from different base stations are communicated in frequency channels which are overlapping (and typically identical). Specifically, a UMTS cellular communication system may comprise a single 5 MHz frequency channel for the uplink and a single 5 MHz frequency channel for the downlink. Each signal has a bandwidth of 5 MHz and the signals from different base stations and remote units overlay each other in the single frequency channel. This is in contrast to frequency division systems wherein a frequency bandwidth available to the system is divided into a large number of relatively narrow frequency channels.

In UMTS, separation between transmitters is achieved by using spread spectrum techniques where different signals are spread using different spreading/scrambling codes. However, in such systems, increased signal power for one remote unit corresponds to increased interference for many other remote units and it is thus very important to control the system to provide suitable performance for as many remote units and services as possible.

For example, the antenna direction of the base stations must be carefully controlled to provide the optimum trade offs between providing sufficient signals for the remote units served by the base station while maintaining a low interference to other remote unit such as those in a neighbour cell. Accordingly, UMTS systems typically comprise means for determining and/or adjusting the downtilt of base station antennas to optimise the coverage versus interference achieved.

Similarly, a pilot signal transmit power may be modified in order to provide adaptation to the specific conditions of the cellular communication system. The transmit powers may thus be modified to provide improved performance by trading off when remote units are served by different cells.

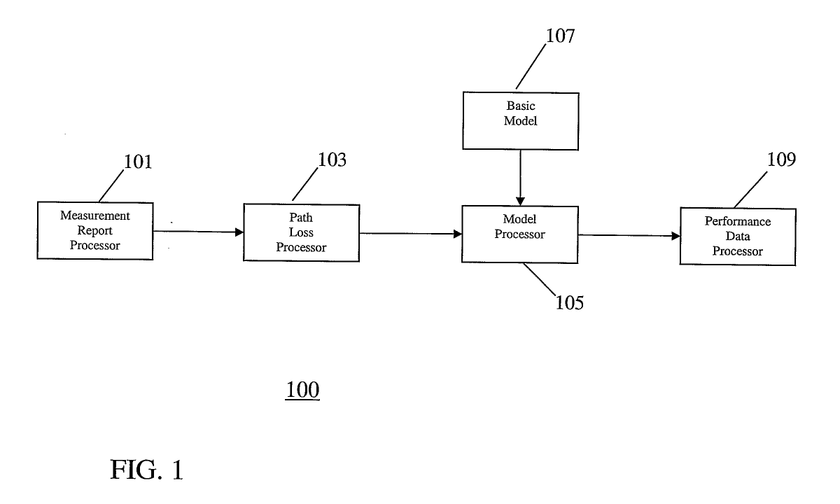

FIG. 1 illustrates an optimisation apparatus 100 for optimisation of a spread spectrum cellular communication system in accordance with some embodiments of the invention. The system will be described with specific reference to optimisation of pilot signal transmit power and/or antenna downtilt/azimuth parameters of a UMTS cellular communication system.

The optimisation apparatus comprises a measurement report processor 101 which collects measurement reports from remote units of the spread spectrum cellular communication system. The remote units may for example be 3^{rd} Generation User Equipments (UEs).

In particular, the measurement report processor 101 is fed a large number of measurement reports received from remote units of the live UMTS communication system. The measurement reports may for example be received from some or all remote units of all cells in the system or of a selected group of cells. The measurement reports may e.g. be received from base stations of the cellular communication system or from one or more Radio Network Controllers (RNCs) of the system.

In the example, the measurement reports comprise signal level measurements for a plurality of cells for each remote unit. In particular, each remote unit reports a received signal to noise ratio, such as an Ec/Io value, for each pilot tone of the cells comprised in the active set, the candidate set or a detected set. The active set comprises the cells which are involved in supporting the remote unit (such as cells supporting legs of a soft handover). The candidate set comprises cells which are candidates for soft or hard handovers. The candidate set may thus comprise all cells of the neighbour list transmitted to the remote unit and which are not included in the active set. The detected set comprises cells neither in the active set nor in the candidate set for the remote unit. The detected set may comprise cells that the first remote unit has measured without external guidance from the network.

In this way, a number of contemporaneous measurements are received which indicates how a specific remote unit receives the pilot signals of some set of cells.

The measurement report processor 101 is coupled to a path loss processor 103 which determines relative path loss data for the remote units. In particular, the contemporaneous measurements of pilot signal levels may be used to determine the relative path loss from the different base stations of the neighbour cells to the remote unit. Thus, the path loss for the individual remote units may not be determined explicitly but it may be determined that the path loss from cell A is e.g. 3 dB higher than the path loss from cell B etc.

The relative path losses may be determined from knowledge of the relative pilot transmit signal powers of the base stations of the neighbour cells.

More specifically, remote units of a UMTS cellular communication system typically report several pilot Ec/Io (carrier energy over interference) values simultaneously in a contemporaneous set. For the Ec/Io measurement of cell k, the measured value is determined by the following expression.

$${( \frac{{E}_{c }}{{I}_{o}} )}^{k} = \frac{\frac{{P}_{pilot}^{k}}{{P}_{L}^{k}}}{{\sum }_{i} \frac{{P}_{tx}^{i}}{{P}_{L}^{i}} + {P}_{N}}$$

where Pₚᵢₗₒₜ^{k} is the power at which the pilot is transmitted by cell k, P_{L}ⁱ is the total propagation loss between the ith cell and the remote unit, Pₜₓⁱ is the total transmit power of the ith cell and P_{N} is the thermal noise in the receiver.

The interference from other cells can be separated into that from cells which are also reported in the measurement report and those which are not. This allows certain expressions involving the relative path loss values to be compensated for interference levels of interference sources which are not explicitly and individually included in measurement reports. Thus, the fixed interference level which cannot be attributed to the cells that are reported (and for which relative path losses are determined) can be taken into account when determining the relative path losses.

Specifically, denoting the set of pilots reported in the measurement report by C and re-writing the equation yields:

$${( \frac{{E}_{c}}{{I}_{o}} )}^{k} = \frac{\frac{{P}_{pilot}^{k}}{{P}_{L}^{k}}}{{\sum }_{i ∈ C} \frac{{P}_{tx}^{i}}{{P}_{L}^{i}} + {\sum }_{i ∉ C} \frac{{P}_{tx}^{i}}{{P}_{L}^{i}} + {P}_{N}}$$

Grouping the last two terms on the denominator and replacing them with a new term results in:

$${( \frac{{E}_{c}}{{I}_{o}} )}^{k} = \frac{\frac{{P}_{pilot}^{k}}{{P}_{L}^{k}}}{{\sum }_{i ∈ C} \frac{{P}_{tx}^{i}}{{P}_{L}^{i}} + O}$$

Here the term O is the sum of the interfering power received from all other cells other than the reported cells along with the thermal noise, i.e. it corresponds to interference (including noise) sources which are not reported. Since the set of Ec/Io measurements are taken within a short time interval, it can be assumed that the common terms do not vary significantly between the set of k equation for the k unknown P_{L} terms.

In fact, the path loss processor 103 may for each remote unit consider the set of simultaneous equations for each reported pilot. In these equations, there is an unknown path loss term for each reported pilot as well as the single common unknown term O.

As there are more unknown variables than equations, it is not possible to determine all the path loss terms and the unknown term O independently by solving the linear system. However, relative path loss terms may be determined. In particular, the above equation may be expressed as:

$${( \frac{{E}_{c}}{{I}_{o}} )}^{k} = \frac{\frac{{P}_{pilot}^{k}}{{P}_{L}^{k} O}}{{\sum }_{i ∈ C} \frac{{P}_{tx}^{i}}{{P}_{L}^{i} O} + 1}$$

The composite terms P_{L}^{k}O may then be recovered for each k in C. Thus, a relative path loss term P_{L}^{k}O may be determined.

This may be done by using the cell transmit powers, the pilot transmit power levels (both of which are known to the network). The following system of equations may be solved:

$$I = \frac{1}{( \frac{Ec}{Io} )} \frac{{P}_{pilot}^{k}}{{P}_{L}^{k} O} - {\sum }_{i ∈ C} \frac{{P}_{tx}^{i}}{{P}_{L}^{i} O} , ∀ k ∈ C$$

Thus, for a given remote unit a relative path loss may be determined for each cell reported in the measurement report.

The path loss processor 103 is coupled to a model processor 105. The model processor is coupled to a basic model store 107 which comprises a template model for communication system. The template model may specifically comprise a number of mathematical equations and relations relating different parameters and characteristics of the communication system. The model processor 105 may retrieve the template model from the basic model store 107 and may determine a set of input parameters to use for the model. Such input parameters may for example be the pilot transmit powers for different cells, typical signal to noise targets for the remote units etc.

The model is then adapted to use the relative path loss data determined by the path loss processor 103. Specifically, the ratio of signal of a wanted signal to interference at the individual remote units may be determined from evaluation of the relative path loss and the transmitted signal power from the cells for which measurement reports are received. Although, this approach ignores how the contribution of non-measured cells has changed from when the measurement report was collected, changes in contribution tend to be negligible if the changes are constrained to within reasonable limits. Moreover the contribution from non-measured cells will typically be less significantly than measured ones. Indeed, the reason for these being included in the measurement report in the first place is that they provide relatively strong signals at the remote unit.

In more detail, the mathematical model-based optimisation of the UMTS system may involve the calculation of received de-spread signal to interference values for traffic channels of individual remote terminals. These may be determined by (denoting the signal to interference ratio by Eb/No):

$$( \frac{{E}_{b}}{{N}_{o}} ) = PG \frac{\frac{{P}_{traf}^{k}}{{P}_{L}^{k}}}{( 1 - γ \frac{{P}_{tx}^{k}}{{P}_{L}^{k}} + {\sum }_{i \neq k} \frac{{P}_{tx}^{i}}{{P}_{L}^{i}} + {P}_{N} )}$$

where k is the serving cell of the remote unit, PG is the processing gain, γ is the orthogonality factor and P_{traf}^{k} is the transmitted power from that cell devoted to that remote unit's traffic channel. As before, this may be converted to use the relative path loss values:

$$( \frac{{E}_{b}}{{N}_{o}} ) = PG \frac{\frac{{P}_{traf}^{k}}{{P}_{L}^{k}}}{( 1 - γ ) \frac{{P}_{tx}^{k}}{{P}_{L}^{k}} + {\sum }_{{i ∈ C}_{i \neq k}} \frac{{P}_{tx}^{i}}{{P}_{L}^{i}} + {\sum }_{i ∉ C} \frac{{P}_{tx}^{i}}{{P}_{L}^{i}} + {P}_{N}}$$

$$( \frac{{E}_{b}}{{N}_{o}} ) = PG \frac{\frac{{P}_{traf}^{k}}{{P}_{L}^{k}}}{( 1 - γ ) \frac{{P}_{tx}^{k}}{{P}_{L}^{k}} + {\sum }_{{i ∈ C}_{i \neq k}} \frac{{P}_{tx}^{i}}{{P}_{L}^{i}} + O}$$

$$( \frac{{E}_{b}}{{N}_{o}} ) = PG \frac{\frac{{P}_{traf}^{k}}{{P}_{L}^{k} O}}{( 1 - γ ) \frac{{P}_{tx}^{k}}{{P}_{L}^{k} O} + {\sum }_{{i ∈ C}_{i \neq k}} \frac{{P}_{tx}^{i}}{{P}_{L}^{i} O} + 1}$$

As the path loss processor 103 has determined the values for all reported cells, all terms are known except for the orthogonality factor γ which may be estimated. In particular, γ may be determined by consideration of the terrain and nature of the built environment.

Accordingly, the model processor 105 may accurately determine the achievable signal to interference ratio that can be achieved for a remote unit in the specific conditions in which the remote unit made the measurements and under the assumption of the used input parameters (such as the transmit powers) of the model. Accordingly, by modifying one of the input parameters, say the antenna downtilt resulting in a different antenna gain and hence path loss, the impact of this change on a remote unit in the conditions of the remote unit when making the measurements may be determined.

A remote unit may furthermore be used several times in the optimisation process. For example, if measurement reports are received from a specific remote unit at a first location these may be included in the determination of the estimated performance data. In addition, measurement reports from the same specific remote unit at a second location may be treated similarly to measurement reports from a different remote unit and may be separately included in the determination of the estimated performance data.

The model processor 105 is coupled to a performance data processor 109 which generates estimated performance data for the cellular communication system from the model.

Specifically, the performance data processor 109 may modify an input parameter for the model and may calculate the achieved signal to interference ratio for the remote units. As the impact of the modified parameter is determined for remote units experiencing the same conditions as the remote units making the original measurements, the impact on the actual communication system may accurately be determined. In particular, by calculating signal to interference ratios for all remote units, the distribution of remote units used by the optimisation automatically corresponds to the distribution in the real system. Thus, a highly practical, efficient, low complexity and accurate estimation of performance data may be achieved resulting in a high performance optimisation.

The performance data processor 109 may e.g. determine the signal to interference ratio for all the remote units and provide a statistical processing to generate data that may be used for the optimisation. For example, an average signal to interference ratio or a percentage of remote units experiencing unacceptable signal to interference ratios may be determined.

The performance data processor 109 may in particular generate estimated performance data for a number of different parameter settings (such as different downtilts or pilot signal powers) and the optimisation may be performed by selecting the parameter set yielding the most advantageous results and applying this parameter set to the system.

The described embodiments furthermore provide for a highly flexible, efficient, low complexity and fast method of optimisation. In particular, only the most relevant information is determined using a low complexity and low computational intensive approach. In particular, the need for repeated random drops and evaluation of absolute propagation models may be mitigated or obviated.

In some embodiments, location estimates for the remote units may be determined and used in the optimisation. This may for example be particularly advantageous for optimisation of antenna downtilt or azimuth if coupled with antenna gain profile data.

In some embodiments, the apparatus may further comprise a calibration processor that calibrates the model in response to an operational characteristic of the communication system.

In particular, the model processor 105 may initially select a first set of values for input parameters that cannot be otherwise measured such as a set of signal to noise targets, orthogonality factors etc. The model may then be evaluated and estimated performance data may be generated. If the input parameters are identical to the corresponding parameters in the real system, it should be expected that the estimated performance data will closely reflect that of the real system.

Accordingly, at least one of the characteristics of the estimated performance data is compared to an operational characteristic. For example, an estimated average signal to interference ratio for the remote stations may be determined and compared to the average signal to interference ratio for the actual measurement reports. If the values do not match closely, the unknown input parameters may be modified and new estimated performance data may be determined for these values. For example, the orthogonality factor or de-spread signal to interference ratio targets may be modified. The process may be iterated until the estimated performance data match the measured values sufficiently closely (according to any suitable criterion).

When the estimated performance data and the measured data correspond closely, the model may be considered to be calibrated to accurately reflect the real communication system. Accordingly, the performance data processor 109 may proceed to modify input parameters individually or as a group and evaluate the resulting estimated performance data to determine the suitability of each modification.

Thus, this approach allows the model to be automatically calibrated for unknown values, such as for example target de-spread signal to interference ratios, bit rates and activity factors, rather than requiring these to be determined explicitly. For example, downlink transmit powers may be collected and compared to the predictions of the model based on an initial estimate of these parameters. The model parameters may then be modified to bring the response closer to reality.

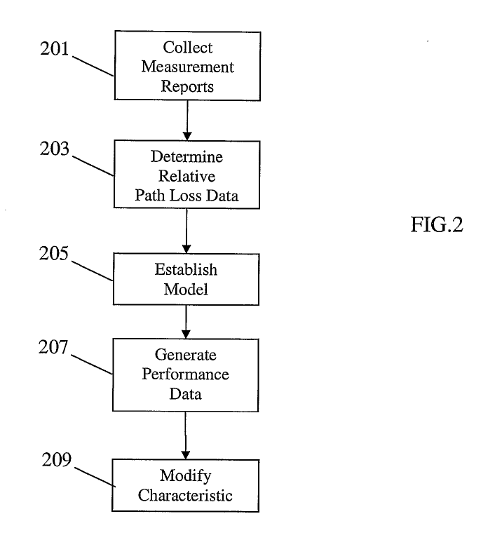

FIG. 2 illustrates an example of a method of optimising a spread spectrum cellular communication system in accordance with some embodiments of the invention.

The method initiates in step 201 wherein measurement reports are collected from remote units of the spread spectrum cellular communication system.

Step 201 is followed by step 203 wherein relative path loss data is determined for the remote units. In particular, relative path loss data for a plurality of cells for each remote unit may be determined. The path loss data may be relative to a constant which is common for the different cells. The constant may specifically be a constant corresponding to an interference level of interference sources not included in the measurement reports of that remote unit.

Step 203 is followed by step 205 wherein a model of the cellular communication system is established in response to the relative path loss data.

Step 205 is followed by step 207 wherein estimated performance data for the cellular communication system is generated from the model.

Step 207 is followed by step 209 wherein a characteristic of the cellular communication system is modified in response to the estimated performance data.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

1. An apparatus for optimising a spread spectrum cellular communication system, the apparatus comprising:
means for collecting measurement reports from remote units of the spread spectrum cellular communication system;
means for determining relative path loss data for the remote units;
means for establishing a model of the cellular communication system in response to the relative path loss data;
means for generating estimated performance data for the cellular communication system from the model.

2. The apparatus of claim 1 wherein the model comprises a number of variable parameters and wherein the means for generating the estimated performance data comprises means for altering a parameter value and generating estimate performance data for the altered parameter value.

3. The apparatus of claim 1 wherein the relative path loss data for a second remote unit comprise a relative path loss estimate for a plurality of cells and the model comprises means for determining a signal to interference estimate for the second remote unit in response to the relative path loss estimates.

4. The apparatus of claim 1 further comprising means for estimating a location of at least some of the remote units and wherein the means for establishing the model is arranged to establish the model in response to the estimated locations.

5. The apparatus of claim 1 wherein the means for determining relative path loss data is arranged to compensate the relative path loss data for at least one remote unit in response to an interference level of interference sources not included in measurement reports for the third remote unit.

6. The apparatus of claim 1 further comprising calibration means for calibrating the model in response to an operational characteristic of the communication system, wherein the calibration means comprise:
means for determining a first set of parameter values for the model;
comparing a first characteristic of the estimated performance data to the operational characteristic; and
means for modifying at least one parameter of the first set of parameters in response to the comparison.

7. The apparatus of claim 1 wherein the relative path loss data comprises path loss data for a remote unit relative to a constant which is common for a plurality of neighbour cells of the remote unit.

8. The apparatus of claim 1 further comprising means for determining an antenna direction in response to the estimated performance data.

9. The apparatus of claim 1 further comprising means for determining a pilot signal transmit power level in response to the estimated performance data.

10. A method of optimising a spread spectrum cellular communication system, the method comprising:
collecting measurement reports from remote units of the spread spectrum cellular communication system;
determining relative path loss data for the remote units;
establishing a model of the cellular communication system in response to the relative path loss data;
generating estimated performance data for the cellular communication system from the model.
